(19) United States
(12) Patent Application Publication
(10) Pub. No.: US 2026/0131352 A1
(43) Pub. Date: May 14, 2026

(54) System And Method For Producing A Coated Panel Component

(71) Applicant: The Boeing Company, Arlington, VA (US)

(72) Inventors: Sergio A Chacon, St. Louis, MO (US); Alexander R Capalupo, Wentzville, MO (US); Remelisa P Esteves, St. Louis, MO (US); Alan F Tegeler, O'Fallon, MO (US)

(73) Assignee: The Boeing Company, c/o Kevin Pumm, Arlington, VA (US)

(21) Appl. No.: 19/440,972

(22) Filed: Jan. 6, 2026

(51) Int. Cl. B05C 11/02; B05D 3/04; B05D 3/06

(52) U.S. Cl. CPC B05C 11/023; B05D 3/04; B05D 3/067

(57) ABSTRACT

A system and method are provided for producing a coated panel component. The system comprises a support for a panel component, on which a fluid medium including a plurality of dispersed particles is to be applied. The panel component is supported on the support, and a magnetic field generating apparatus including an array of coils is configured to generate a magnetic field with a magnetic field direction that is oriented in a plurality of directions that at least includes a direction that is normal to the surface of the panel component. The system further includes a curing apparatus configured to cure the fluid applied to the panel such that the plurality of particles in the fluid medium are secured in alignment with the direction of the applied magnetic field.

### FIELD

The present disclosure relates to vehicle panel components with coatings that contain particles therein, and methods for producing such coated panel components.

### BACKGROUND

This section provides background information related to the present disclosure which is not necessarily prior art.

While vehicle panels have had fluid mediums applied thereto for purposes of providing a coating thereon, where the coating may contain particles therein, there is a need for an improved system and method for producing a coated panel component for a vehicle in which the particles within the fluid medium may be oriented.

### SUMMARY

This section provides a general summary of the disclosure, and is not a comprehensive disclosure of its full scope or all of its features.

According to the present disclosure, exemplary embodiments of a system are provided for producing a coated panel component. The system comprises a support for a panel component, on which a fluid medium including a plurality of dispersed particles is to be applied. The panel component is supported on the support, and a magnetic field generating apparatus including an array of coils is configured to generate a magnetic field with a magnetic field direction that is oriented in a plurality of directions that at least includes a direction that is normal to the surface of the panel component. The current to the array of coils is controlled such that the direction of the generated magnetic field causes the plurality of particles dispersed in the fluid medium to align with the direction of the magnetic field. The system further includes a curing apparatus configured to cure the fluid applied to the panel such that the plurality of particles in the fluid medium are secured in alignment with the direction of the applied magnetic field.

In another aspect of the present disclosure, exemplary embodiments of a method are provided for producing a coated panel, comprising the steps of supporting, on a support, a panel component, on which a fluid medium including a plurality of dispersed particles is to be applied, applying, using a magnetic field generating apparatus that includes an array of coils configured to generate a magnetic field, a magnetic field with a magnetic field direction that is oriented in a plurality of directions that at least includes a direction that is normal to the surface of the panel component, controlling the current to the array of coils such that the direction of the generated magnetic field causes the plurality of particles dispersed in the fluid medium to align with the direction of the magnetic field, and curing, using a curing apparatus, the fluid applied to the panel such that the plurality of particles in the fluid medium are secured in alignment with the direction of the applied magnetic field.

Further areas of applicability will become apparent from the description herein. The description and specific examples in the summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an exemplary embodiment of a system for producing a panel component on which a fluid medium including a plurality of dispersed particles is to be applied, according to the present disclosure;

FIG. 2 is an illustration of an exemplary embodiment of a system for producing a panel component on which a fluid medium including a plurality of dispersed particles is to be applied, according to the present disclosure;

FIG. 3 is an illustration of the system shown in FIG. 2;

FIG. 4 is an illustration of a coated panel component produced by the system shown in FIGS. 2 and 3, and

FIG. 5 is an illustration of a method for producing a panel component on which a fluid medium including a plurality of dispersed particles is applied, according to the present disclosure.

Corresponding reference numerals indicate corresponding parts throughout the several views of the drawings.

### DETAILED DESCRIPTION

Example embodiments will now be described more fully with reference to the accompanying drawings. The features, functions and advantages discussed in the preceding section can be achieved independently in various embodiments or may be combined in yet other embodiments. Further aspects of the present disclosure can be seen with reference to the drawings and following described exemplary embodiments.

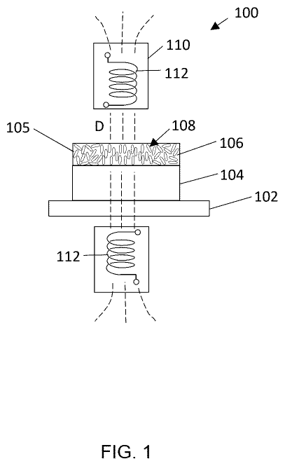

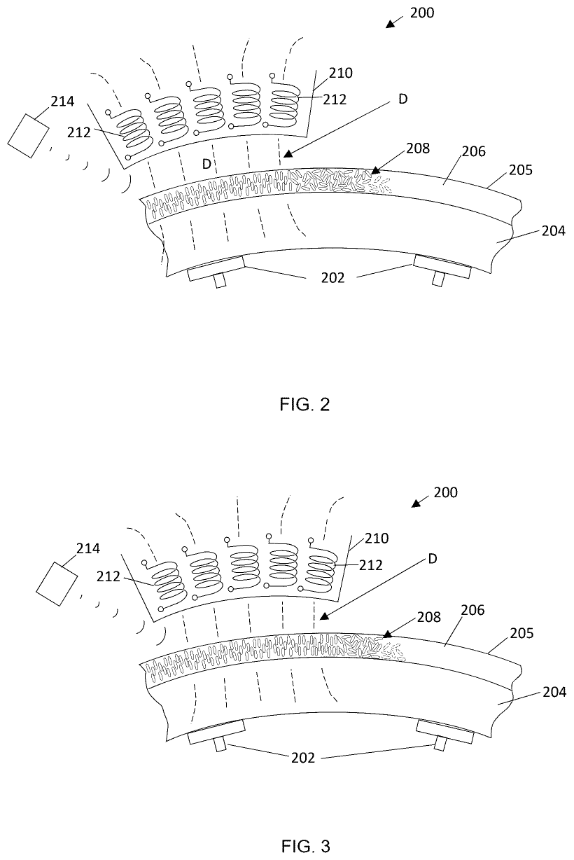

Referring to FIG. 1, one example is shown of a system 100 for producing a coated panel component, comprising a support 102 for a panel component 104, on which a fluid medium 106 including a plurality of dispersed particles 108 is to be applied. The panel component 104 may be for a ground based vehicle or an aerial vehicle. The panel component 104 is supported on the support 102; and a magnetic field generating apparatus 110, which includes an array of coils 112 configured to generate a magnetic field with a magnetic field direction D that is oriented in a plurality of directions that at least includes a direction that is normal to the surface of the panel component 104. The current that is applied to the array of coils 112 is controlled such that the direction D of the generated magnetic field causes the plurality of particles 108 dispersed in the fluid medium 106 to align with the direction of the magnetic field. A curing apparatus 114 is configured to cure the fluid medium 102 applied to the panel component 104 such that the plurality of particles 108 in the fluid medium 106 are secured in alignment with the direction of the applied magnetic field. The plurality of particles 108 may be oriented in a substantially uniform direction within the cured fluid medium across the surface of the panel component 104. Alternatively, in another example, the plurality of particles 108 are oriented in a direction that is varied across the span of the panel component 104. The fluid medium 106 may comprise a light transmissive material that permits transmission of light into the fluid medium in which the plurality of particles are aligned. The fluid medium 106 may comprise a transparent or translucent medium, or other suitable materials that permit the transmission of light therethrough. In one example, the fluid medium 106 may comprise an uncured epoxy or polymer, or resin matrix, which is configured to be cured through convection of ambient air temperature, or by heating to a predetermined temperature, or by exposure to emitted ultraviolet radiation. The fluid medium 106 preferably comprises a material that is in a liquid state that is capable of being sprayed or deposited onto the surface of the panel component by spraying or deposition via a sprayer or deposition device. The fluid medium 106 comprises a material that is configured to be cured by application of one of an air moving device, a heating device, or an ultraviolet emitting device. The plurality of particles 108 that are dispersed within the fluid medium 106 may be a material that is comprises of one or more elements of the first transition series and compound thereof. More preferably, the plurality of particles 108 that are dispersed within the fluid medium 106 may be a material that is comprises of one or more elements of groups 8, 9 and 10 of the first transition series and compound or alloys thereof. Preferably, the plurality of particles 108 are made of a material that is ferromagnetic, or responsive to an applied magnetic field. The plurality of particles 108 are of a size in the range of between 0.0005 inches and 0.0625 inches. More preferably, the plurality of particles 108 are of a size in which the maximum dimension across the particle is 0.015625 inches and the minimum dimension across the particle is at least 0.001 inches. The thickness of the coating of the fluid medium 106 is in a range of between 0.001 inches and 0.125 inches. The panel component 104 may have a generally planar shape as shown in FIG. 1. Alternatively, the panel component 104 may have a generally curved surface, as shown in FIG. 2. The panel component 104 may have a curved surface with a minimum curvature that slopes about 0.0125 inches across a span of 12 inches, for example.

Referring to FIG. 2, another example is shown of a system 200 for producing a coated panel component, comprising a support 202 for a panel component 204, on which a fluid medium 206 including a plurality of dispersed particles 208 is to be applied. The panel component 204 may be curved in shape, and is supported on the support 202. A magnetic field generating apparatus 210 includes an array of coils 212 configured to generate a magnetic field with a magnetic field direction D that is oriented in a plurality of directions that at least includes a direction that is normal to the surface of the panel component 204. The magnetic field generating apparatus 210 may have a generally curved shape, and the array of coils 212 may be arranged in an arcuate configuration, such that the orientation of the coils is generally normal to the lower side of the curved magnetic field generating apparatus coils 212. The current that is applied to the array of coils 212 is controlled such that the direction D of the generated magnetic field causes the plurality of particles 108 dispersed in the fluid medium 206 to align with the direction of the magnetic field. A curing apparatus 214 is configured to cure the fluid medium 202 applied to the panel component 204 such that the plurality of particles 208 in the fluid medium 206 are secured in alignment with the direction of the applied magnetic field. The plurality of particles 208 may be oriented in a substantially uniform direction within the cured fluid medium across the surface of the panel component 204. Alternatively, in another example, the plurality of particles 208 are oriented in a direction that is varied across the span of the panel component 204.

Referring to FIG. 3, the system 200 is shown with the fluid medium 206 being cured in a first region, where the plurality of particles 208 within the fluid medium 206 in the first region have been aligned with the direction of generated magnetic field and are secured within the cured fluid medium 206, where the magnetic field generating apparatus 210 has been displaced (or moved above) the panel component 204 such that the plurality of particles 208 dispersed within the fluid medium 208 in an adjacent region may be aligned with the direction of the generated magnetic field and cured, to iteratively cause the plurality of particles in the fluid medium 200 to be aligned in a progressive manner across the span of the curved panel component.

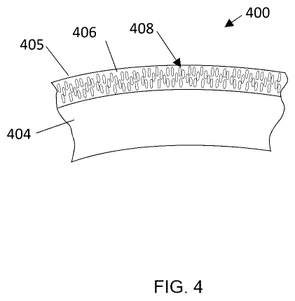

Referring to FIG. 4, an example is shown of a component 400 that can be produced by the system 200. The panel component 400 has a cured coating that comprises a fluid medium 406 including a plurality of dispersed particles 408 therein. The fluid medium 400 is applied to panel component 404 as a coating. The plurality of particles 408 dispersed in the fluid medium 406 are aligned with the direction of a magnetic field generated by an array of coils configured to generate a magnetic field with a magnetic field direction that is oriented in a plurality of directions that at least includes a direction normal to the surface of the panel component 404. The fluid medium 406 in which the plurality of particles 408 are dispersed is cured such that the plurality of particles 408 in the fluid medium 406 are secured in alignment with the direction of the applied magnetic field.

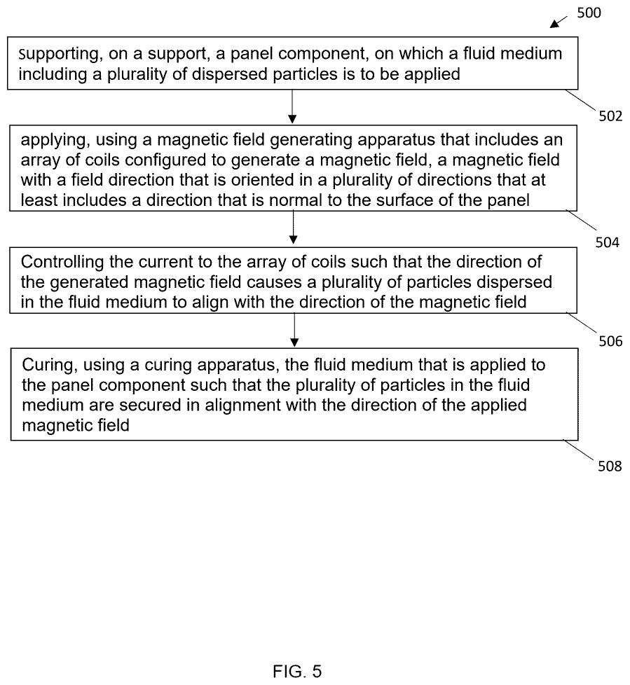

Referring to FIG. 5, an illustration of a flowchart is shown, depicting an example of a method 500 for producing a coated panel, comprising the steps of supporting 502, on a support, a panel component, on which a fluid medium including a plurality of dispersed particles is to be applied. The method includes applying 504, using a magnetic field generating apparatus that includes an array of coils configured to generate a magnetic field, a magnetic field with a magnetic field direction that is oriented in a plurality of directions that at least includes a direction that is normal to the surface of the panel component, and controlling 506 the current to the array of coils such that the direction of the generated magnetic field causes the plurality of particles dispersed in the fluid medium to align with the direction of the magnetic field. The method further includes curing 508, using a curing apparatus, the fluid applied to the panel such that the plurality of particles in the fluid medium are secured in alignment with the direction of the applied magnetic field. The method 500 may further include generating a magnetic field that is in a direction that causes the plurality of particles to be oriented in a substantially uniform direction within the cured fluid medium across the surface of the panel component. In the method 500, the generated magnetic field is in a direction that causes the plurality of particles are oriented in a direction that is varied across the span of the panel component. The method 500 may further include controlling the current to the array of coils such that the direction of the generated magnetic field has a magnetic field direction that is oriented normal to the surface of the panel component to cause the plurality of particles dispersed in the fluid medium to align with the direction of the magnetic field in a substantially uniform direction across the panel component. The method 500 may further include applying the liquid medium material that is in a liquid state by using a sprayer to deposit the liquid medium onto the surface of the panel component. In the method 500, the fluid medium may comprise a light transmissive material that permits transmission of light into the fluid medium in which the plurality of particles are aligned. In the method 500, the plurality of particles that are dispersed within the fluid medium are of a size in the range of between 0.0005 inches and 0.0625 inches. More preferably, in the method 500, the plurality of particles that are dispersed within the fluid medium are of a size in which the maximum dimension across the particle is 0.015625 inches and the minimum dimension across the particle is at least 0.001 inches. The method 500 may further include curing the fluid material by application of one of an air moving device, a heating device, or an ultraviolet emitting device.

The examples are provided to convey aspects of the apparatus and method to those skilled in the art. Numerous specific details are set forth such as examples of specific components, devices, and methods. It will be apparent to those skilled in the art that the examples may be embodied and/or modified in many different forms and should not be construed to limit the scope of the disclosure. In some examples, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A system for producing a coated panel component, comprising:
a support for a panel component, on which a fluid medium including a plurality of dispersed particles is to be applied,
a panel component supported on the support;
a magnetic field generating apparatus, including an array of coils configured to generate a magnetic field with a magnetic field direction that is oriented in a plurality of directions that at least includes a direction that is normal to the surface of the panel component,
wherein the current to the array of coils is controlled such that the direction of the generated magnetic field causes the plurality of particles dispersed in the fluid medium to align with the direction of the magnetic field, and
a curing apparatus configured to cure the fluid applied to the panel component such that the plurality of particles in the fluid medium are secured in alignment with the direction of the applied magnetic field.

2. The system of claim 1, wherein the plurality of particles are oriented in a substantially uniform direction within the cured fluid medium across the surface of the panel component.

3. The system of claim 1, wherein the plurality of particles are oriented in a direction that is varied across the span of the panel component.

4. The system of claim 1, wherein the fluid medium may comprise a light transmissive material that permits transmission of light into the fluid medium in which the plurality of particles are aligned.

5. The system of claim 1, wherein the fluid medium comprises a material that is in a liquid state that is capable of being sprayed or deposited onto the surface of the panel component by spraying or deposition via a sprayer or deposition device.

6. The system of claim 5, wherein the fluid medium comprises a material that is configured to be cured by application of one of an air moving device, a heating device, or an ultraviolet emitting device.

7. The system of claim 6, wherein the plurality of particles are of a size in the range of between 0.0005 inches and 0.0625 inches.

8. The system of claim 6, wherein the plurality of particles are of a size in which the maximum dimension across the particle is 0.015625 inches and the minimum dimension across the particle is at least 0.001 inches.

9. The system of claim 1, wherein the thickness of a coating of the fluid medium is in a range of between 0.001 inches and 0.125 inches.

10. The system of claim 1, wherein the panel component has a generally curved surface.

11. A method 500 for producing a coated panel, comprising the steps of:
supporting, on a support, a panel component, on which a fluid medium including a plurality of dispersed particles is to be applied,
applying, using a magnetic field generating apparatus that includes an array of coils configured to generate a magnetic field, a magnetic field with a magnetic field direction that is oriented in a plurality of directions that at least includes a direction that is normal to the surface of the panel component,
controlling the current to the array of coils such that the direction of the generated magnetic field causes the plurality of particles dispersed in the fluid medium to align with the direction of the magnetic field, and
curing, using a curing apparatus, the fluid medium that is applied to the panel component such that the plurality of particles in the fluid medium are secured in alignment with the direction of the applied magnetic field.

12. The method of claim 11, wherein the generated magnetic field is in a direction that causes the plurality of particles to be oriented in a substantially uniform direction within the cured fluid medium across the surface of the panel component.

13. The method of claim 11, wherein the generated magnetic field is in a direction that causes the plurality of particles are oriented in a direction that is varied across the span of the panel component.

14. The method of claim 11, further comprising controlling the current to the array of coils such that the direction of the generated magnetic field has a magnetic field direction that is oriented normal to the surface of the panel component to cause the plurality of particles dispersed in the fluid medium to align with the direction of the magnetic field in a substantially uniform direction across the panel component.

15. The method of claim 11, further comprising applying the liquid medium material that is in a liquid state by using a sprayer to deposit the liquid medium onto the surface of the panel component.

16. The method of claim 11, wherein the wherein the fluid medium comprises a light transmissive material that permits transmission of light into the fluid medium in which the plurality of particles are aligned.

17. The method of claim 11, wherein the plurality of particles are of a size in the range of between 0.0005 inches and 0.0625 inches.

18. The system of claim 11, wherein the plurality of particles are of a size in which the maximum dimension across the particle is 0.015625 inches and the minimum dimension across the particle is at least 0.001 inches.

19. The method of claim 11, wherein the fluid medium is configured to be cured by application of one of an air moving device, a heating device, or a ultraviolet emitting device.

20. A vehicle panel assembly, comprising:
a panel component,
a fluid medium including a plurality of dispersed particles therein, applied to panel as a coating,
wherein the plurality of particles dispersed in the fluid medium are aligned with the direction of the magnetic field generated by an array of coils configured to generate a magnetic field with a magnetic field direction that is oriented in a plurality of directions that at least includes a direction normal to the surface of the panel component,
wherein the fluid medium in which the plurality of particles are dispersed is cured such that the plurality of particles in the fluid medium are secured in alignment with the direction of the applied magnetic field.
